(19) United States
(12) Patent Application Publication
(10) Pub. No.: US 2008/0191000 A1
(43) Pub. Date: Aug. 14, 2008

(54) Advertisement Mailer and Method

(76) Inventor: Bruce Scott Glasser, Closter, NJ (US)

Correspondence Address: GORDON & JACOBSON, P.C., 60 LONG RIDGE ROAD, SUITE 407, STAMFORD, CT, 06902, US

(21) Appl. No.: 11/674,749

(22) Filed: Feb. 14, 2007

(51) Int. Cl. B42D 15/00

(52) U.S. Cl. 229/92.8

(57) ABSTRACT

In one embodiment a direct mailer is made essentially of a single piece of paper or other material having on a first side an addressee and a postage indicator and having on a second opposite side at least six advertisers' advertisements and an indication of discounts (e.g., coupons) associated with at least three of those advertisements. The paper or other material, which is preferably folded as a bi-fold, tri-fold, quad-fold, or more, can have a final folded size which permits the mailer to qualify for bulk mail rates. In another embodiment, the direct mailer is made essentially of a single piece of folded paper or other material having on the addressee and postage indicators on the same side as the at least six advertisers' advertisements and indications of discounts associated with at least three of those advertisements.

### BACKGROUND OF THE INVENTION

1. Field of the Invention

This invention relates broadly to advertisements. More particularly, this invention relates to direct marketing mailers.

2. State of the Art

Advertising takes many forms. One “tried and true” advertising technique is direct marketing, and probably the most commonly used medium for direct marketing is direct mail in which marketing communications are sent to customers using the postal service. Direct mail permits the marketer to design marketing pieces in many different formats including, for example, postcards, self-mailers, envelope mailers, and catalogs. Self-mailers are typically single sheets of paper that have been printed and folded, addressed and mailed. For instance, a common practice is to print a page-length advertisement or promotion on one side of a sheet of paper which is folded in half or in thirds, with a promotional message printed on the inside. The two outside surfaces are then used for the address of the recipient and optionally for a message designed to persuade the customer to open the piece. Envelope mailers are mailers in which the material of multiple marketers is included on separate inserts inside a single envelope. VALPAK® is an example of a well-known envelope mailer.

Primary advantages of direct mail marketing are the ability to precisely target previous customers and the ability to gather information based on the response. In particular, because of its direct nature, direct mail advertising can be utilized to determine optimal offers and/or timing, and also permits future mailings to be better targeted. On the other hand, a disadvantage of direct mail marketing is that it is costly. While envelope mailers are used in an effort to share costs among multiple vendors, because separate advertisements are provided in a large stack, consumers tend to discard the entire mailing as it takes time and effort to sort through the advertising materials.

### SUMMARY OF THE INVENTION

It is therefore an object of the invention to provide a new type of direct mailer.

It is another object of the invention to provide a direct mailer which is easily and quickly accessible to potential customers

It is a further object of the invention to provide an advertising mailer which includes multiple advertisements of multiple vendors on a single folded page.

In accord with these objects, which will be discussed in detail below, a direct mailer is provided and consists essentially of a single piece of folded paper having on one side an addressee indicator and a postage indicator and having on the other side at least six advertisers' advertisements and an indication of discounts (e.g., coupons) associated with at least three of those advertisements. The paper, which may be a bi-fold, tri-fold, quad-fold, five-fold or more, preferably has a final folded size which permits the mailer to qualify for bulk mail rates (e.g., a final folded size of less than 6.125×11.5 inches in the United States). According to one embodiment, the paper is horizontally and/or vertically scored to permit detachment of the advertisements. The advertisements may be laid out in any desired format. In one embodiment the advertisements are rectangular. In another embodiment, the advertisements are all of the same size. In one embodiment at least fifty percent of the advertisements have a discount (e.g., coupon) associated with the advertisement. In another embodiment, indications of discounts are associated with all of the advertisements.

Advertising methods include: soliciting at least six advertisers to contract for advertising space in a direct mailer consisting essentially of a single piece of folded paper having on one side an addressee and a postage indicator and having on the other side the advertisers' advertisements and an indication of coupons associated with at least three of those advertisements, and generating and mailing the direct mailers to at least two hundred addressee recipients. The mailers are typically generated by laying out the advertisers' advertisements, printing the advertisements on one side of the paper, folding the paper to a final folded size which permits the mailer to qualify for bulk mail rates, and securing the paper so that it will not open. Addresses and postage are applied to the non-advertisement side of the mailer paper prior to, concurrent with, or after printing of the advertisement side typically by printing the address and postage. A return address may also be applied.

Another embodiment of a direct mailer consists essentially of a single piece of folded paper having the addressee indicator and postage indicator on the same side as the advertisers' advertisements and the indication of discounts (e.g., coupons) associated with those advertisements, with the addressee and postage indicators located in one folded section, and the advertisements located in other folded sections. Methods associated with this embodiment are similar to the methods associated with the other embodiments of the invention.

Additional objects and advantages of the invention will become apparent to those skilled in the art upon reference to the detailed description taken in conjunction with the provided figures.

### BRIEF DESCRIPTION OF THE DRAWINGS

FIG. 1 is a reduced size diagram of one side of an unfolded tri-fold mailer.

FIG. 2 is a schematic diagram of the other side of the tri-fold mailer of FIG. 1.

FIG. 3 is a schematic diagram of the tri-fold mailer of FIG. 1 folded in position to be mailed.

FIG. 4 is a schematic diagram of the tri-fold mailer with vertical scores.

FIG. 5 is a schematic diagram of the tri-fold mailer with vertical and horizontal scores.

FIG. 6 is a schematic diagram of one side of an unfolded tri-fold mailer having advertisements of different sizes.

FIG. 7 is a schematic diagram of one side of an unfolded tri-fold mailer with an indication that all advertisements are entitled to a coupon discount.

FIG. 8 is a schematic diagram of one side of a bi-fold mailer.

FIG. 9 is a reduced size diagram of one side of a five-fold mailer.

FIG. 10 is a schematic diagram of a quad-fold mailer in accord with another embodiment of the invention.

### DETAILED DESCRIPTION OF THE PREFERRED EMBODIMENTS

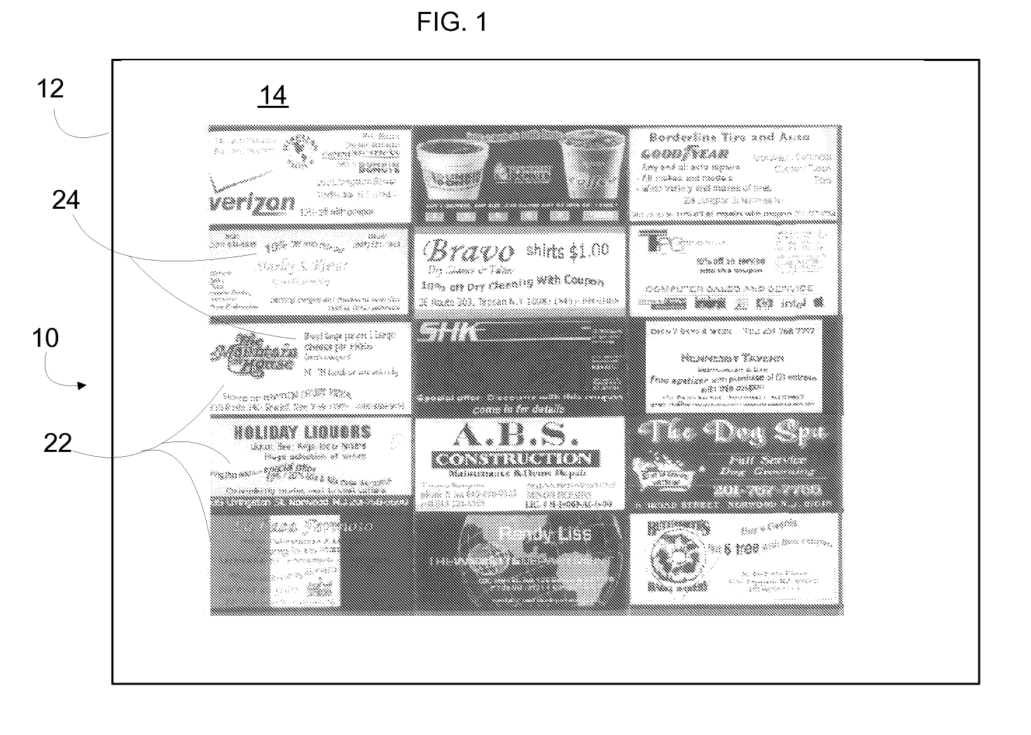

Turning now to FIGS. 1-3, a first embodiment of the invention is seen. A tri-fold mailer 10 consists essentially of a single piece of paper 12 having a first side 14 and a second side 18. The first side 14 includes at least six printed advertisements 22 (fifteen shown) of advertisers. At least three of those advertisements 22 have discount coupons 24 associated therewith. As shown in FIG. 1, each of the advertisements is rectangular in shape, and all are of the same size. The second (opposite) side 18 of the paper 12 includes in one tri-fold portion 26 (folds shown with lines 27 and preferably corresponding to borders between advertisements on side 14) an indicator 32 of an addressee and a postage indicator 34 which are both preferably printed on second side 18, although they may be applied with labels and stamps. In addition, an indication 36 of a return address is provided either by printing or label. The addressee indicator 32 is generally centrally located in the tri-fold portion 26, while the postage indicator 34 is located in a top right-hand side of the tri-fold portion 26 and the indicator 36 of a return address is provided in a top left-hand side of the tri-fold portion. As will be appreciated by those skilled in the art, because numerous mailers are generated and sent, the addressee will change for each mailer (i.e., indicator 32 will change on each piece of paper generated). However, for any given mailing, the advertisements 22 will be the same.

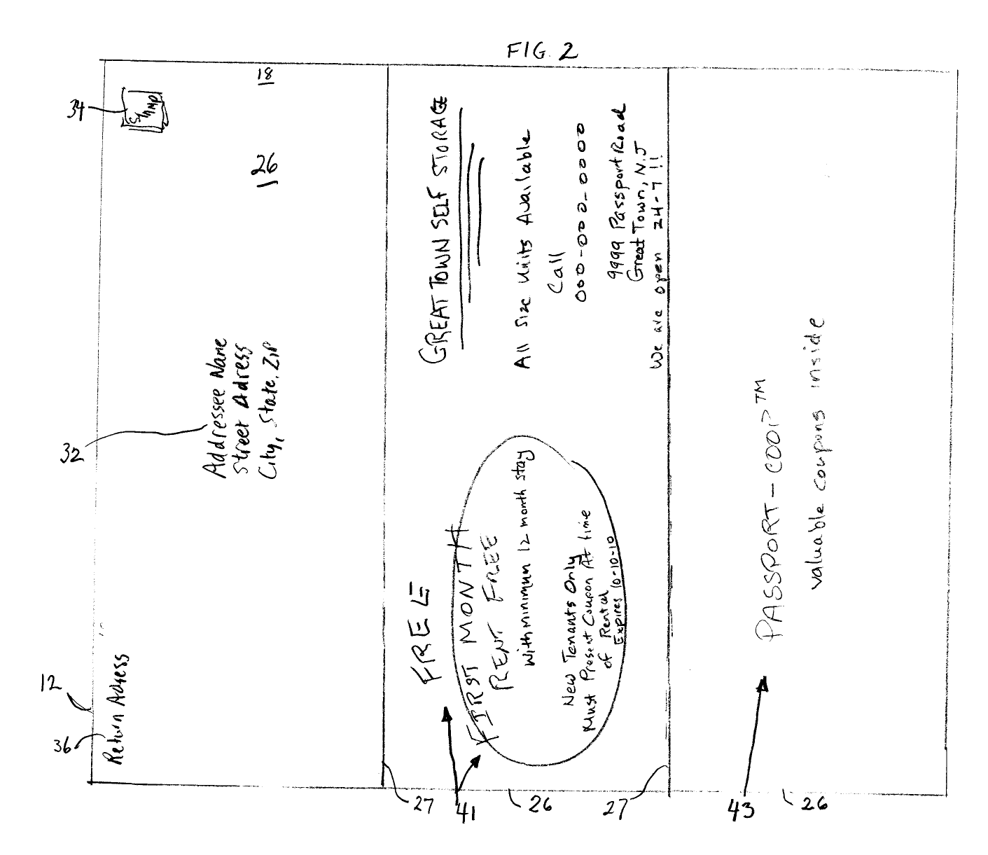

If desired, additional material can be printed on the second “non-advertisement” side 18 of the mailer 10. Thus, as shown in FIG. 2, a large advertisement 41 is provided in one tri-fold area which would typically be sold to an advertiser at a premium. In addition, a self-advertisement 43 which indicates the contents of the mailer is shown provided in a third tri-fold area. It will be appreciated that the additional advertisements need not be provided on the “non-advertisement” side 18 of the mailer. If desired, the tri-fold areas which do not contain the addressee and postage indicators may be used to make the mailer more attractive, left blank, or may be used for other purposes.

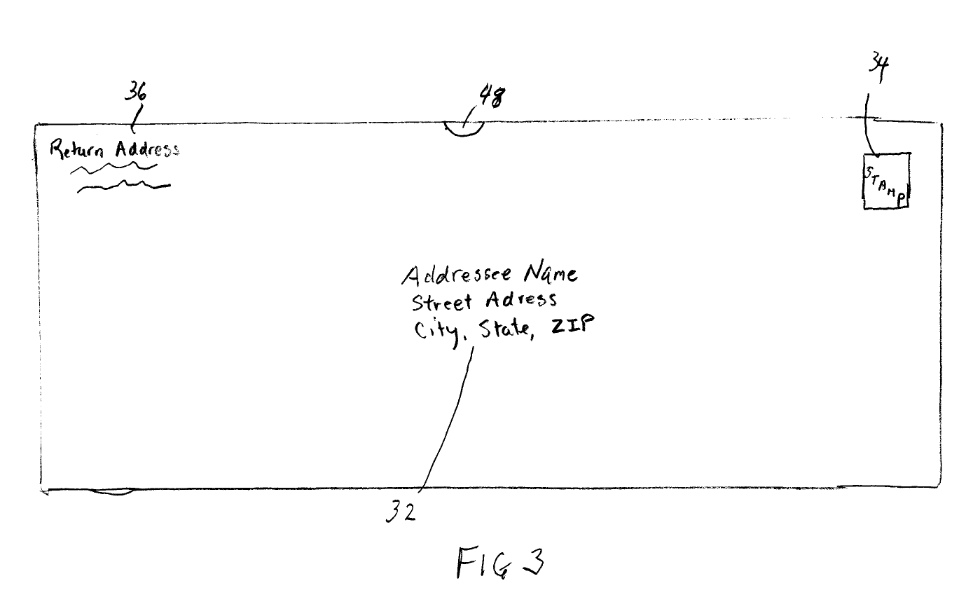

According to the preferred embodiment of the invention, the paper 12 when folded in three has a folded size which permits the mailer to qualify for bulk mail rates (e.g., a final folded size of less than 6.125×11.5 inches in the United States). In addition, as seen in FIG. 3, in order to prevent the mailer from prematurely opening, a securing means 48 is provided. The securing means shown in FIG. 3 is a round sticky tab which is folded over an end and a folded edge of the folded paper 12. However, other securing means such as tape, a staple, etc. can be utilized.

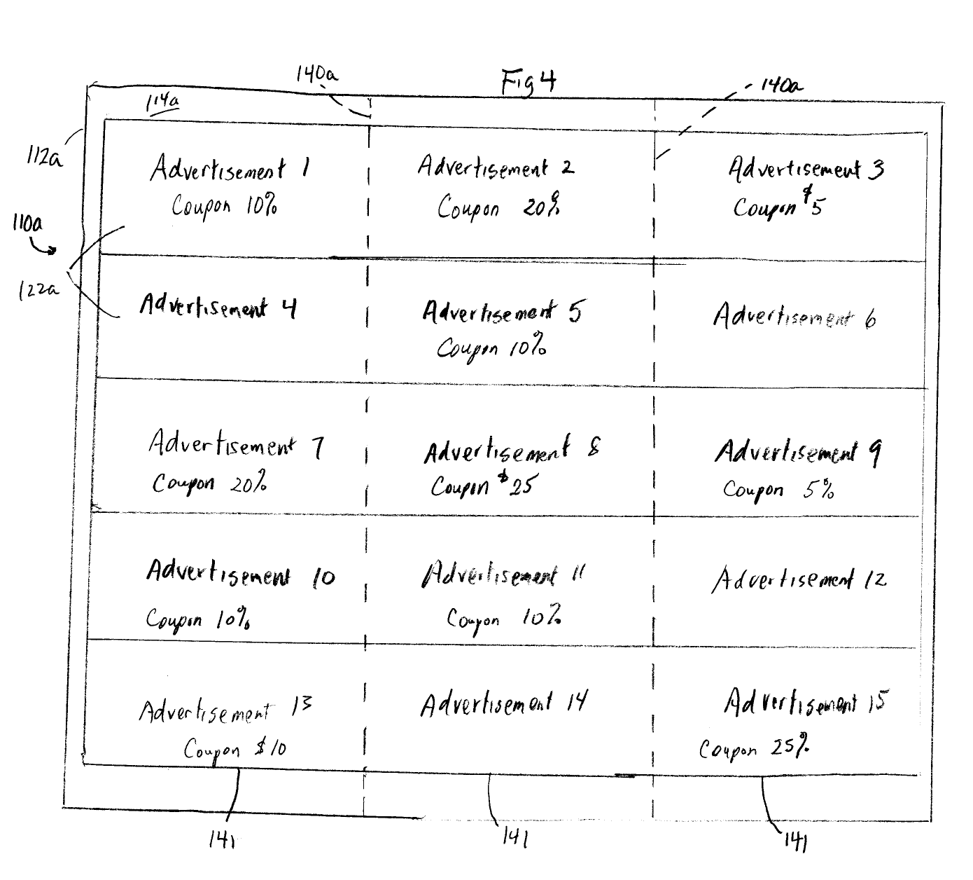

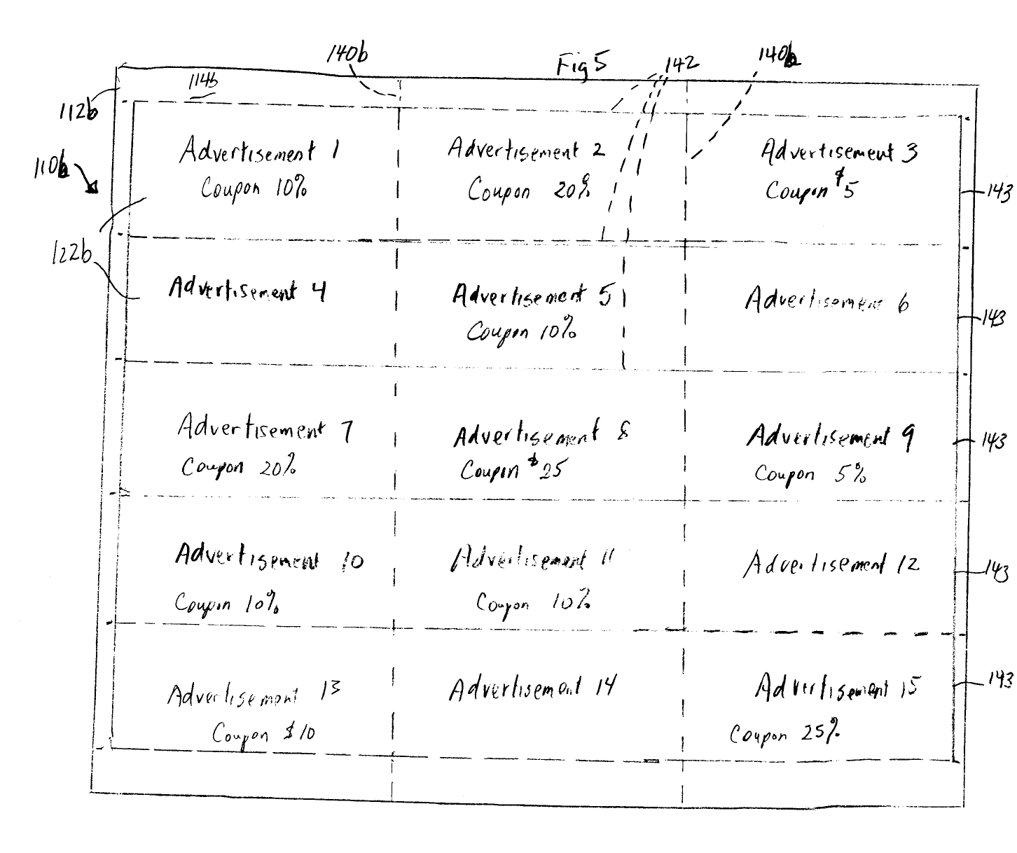

Turning now to FIGS. 4 and 5, according to alternative embodiments of the invention, tri-fold mailers 110a, 110b are provided substantially as the mailer 10 of FIGS. 1-3 such that the mailers consist essentially of single pieces of paper 112a, 112b having first sides 114a, 114b and second sides (not shown). The first sides include at least six advertisements 122a, 122b (fifteen shown) of advertisers with least three of those advertisements have discount coupons 124a, 124b associated therewith. The second sides are preferably substantially as shown in FIG. 2. The difference between the mailer 110a of FIG. 4 and the mailer 10 of FIG. 1 is that mailer 110a has at least two vertical (relative to the advertising layout) scores 140a (shown with dotted lines). Preferably, a vertical score is provided between each column 141 of advertisements 122a. Similarly, the difference between the mailer 110b of FIG. 5 and the mailer 10 of FIG. 1 is that mailer 110b has at least one and preferably a plurality of horizontal (relative to the advertising layout) scores 142 (shown with dotted lines), and preferably at least two vertical scores 140b (shown with dotted lines). The horizontal scores are preferably provided between each row 143 of advertisements. The horizontal and/or vertical scores of the embodiments of FIGS. 4 and 5 readily permit detachment of the advertisements from each other.

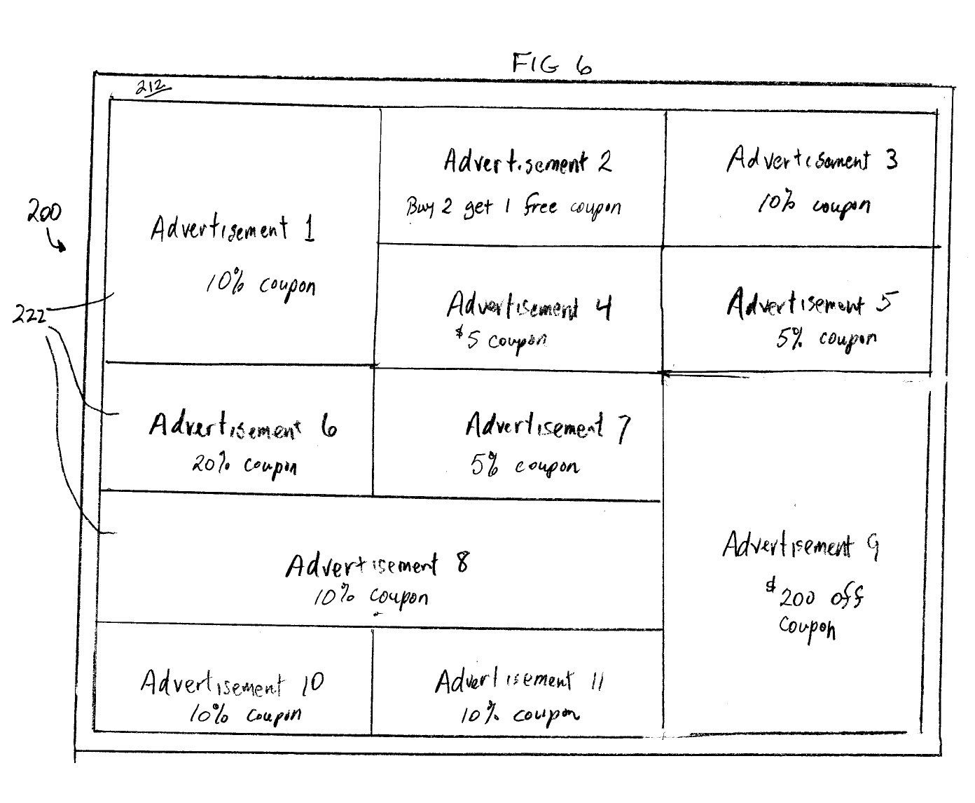

In the embodiments shown in FIGS. 1-5, the advertisements shown for the mailers are of identical sizes and laid out in a grid. However, the advertisements may be laid out in any desired format and need not be of uniform size. For example, as seen in FIG. 6 an unfolded tri-fold mailer 200 having advertisements 222 of different sizes on side 212 is seen. While in FIG. 6, all of the advertisements are based on a grid, are rectangular, and an integer number (e.g., one, two, three, etc.) of basic grid blocks, it will be appreciated that the advertisements need not be based on a grid and need not be rectangular.

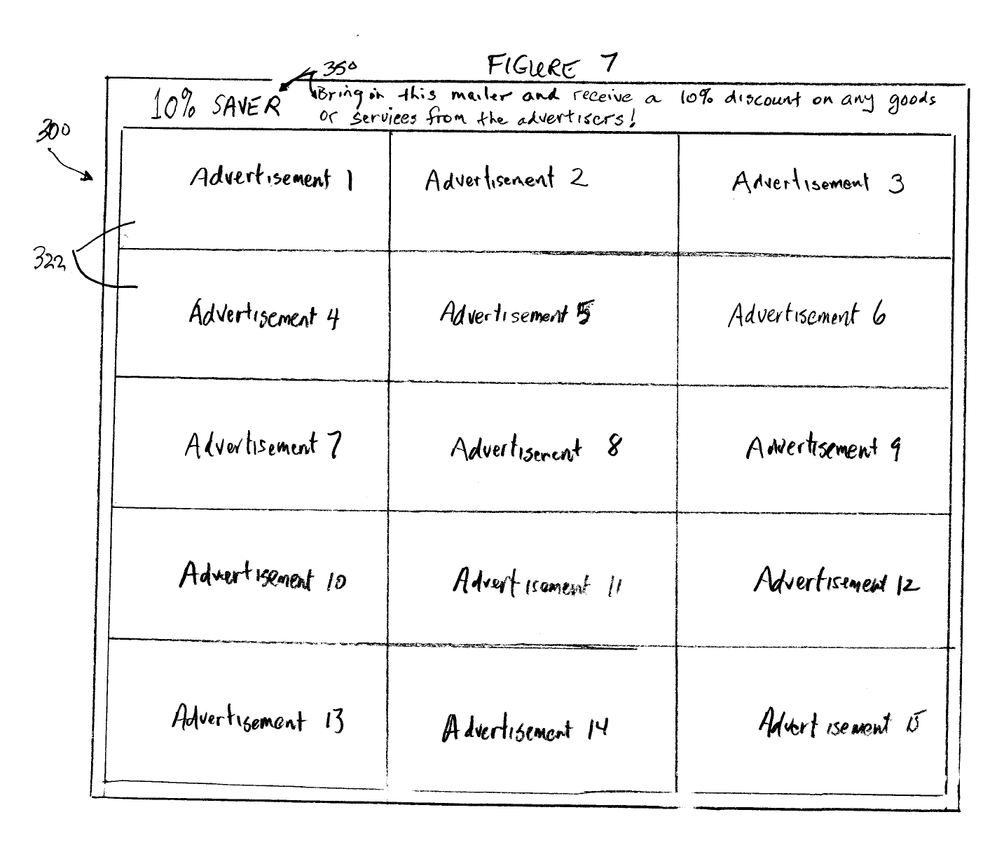

According to the invention, at least three of the advertisements, preferably at least half of the advertisements, and optionally all of the advertisements are associated with a discount. This may be accomplished by providing a coupon indication with particular advertisements as seen in FIG. 1. Alternatively, as seen in FIG. 7 a mailer 300 is provided with an indication 350 that all advertisements 322 of the mailer are entitled to a particular discount (e.g., 10% off). With such an arrangement, each advertisement would preferably include an ID number (not shown) to permit the advertiser to connect the advertisement to a particular mailer campaign so that the discount will be known to the advertiser.

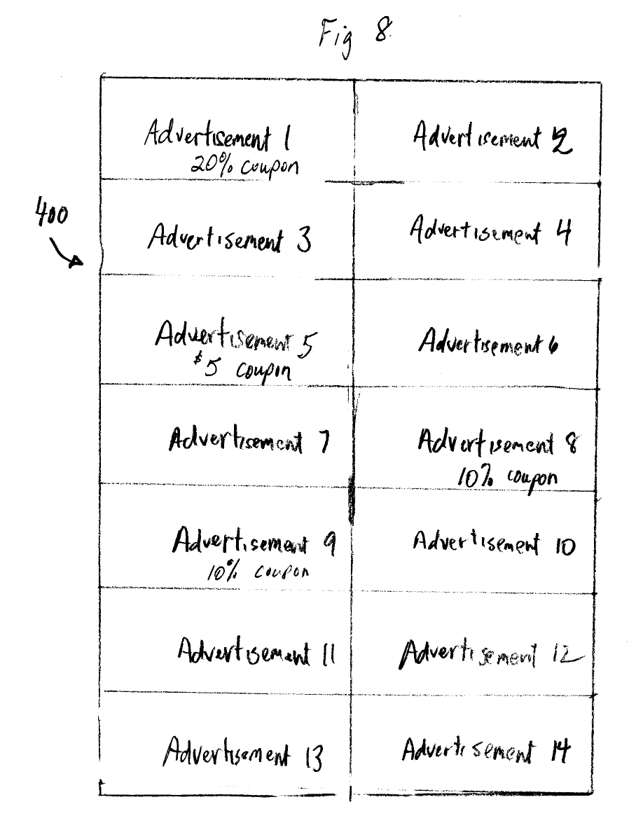

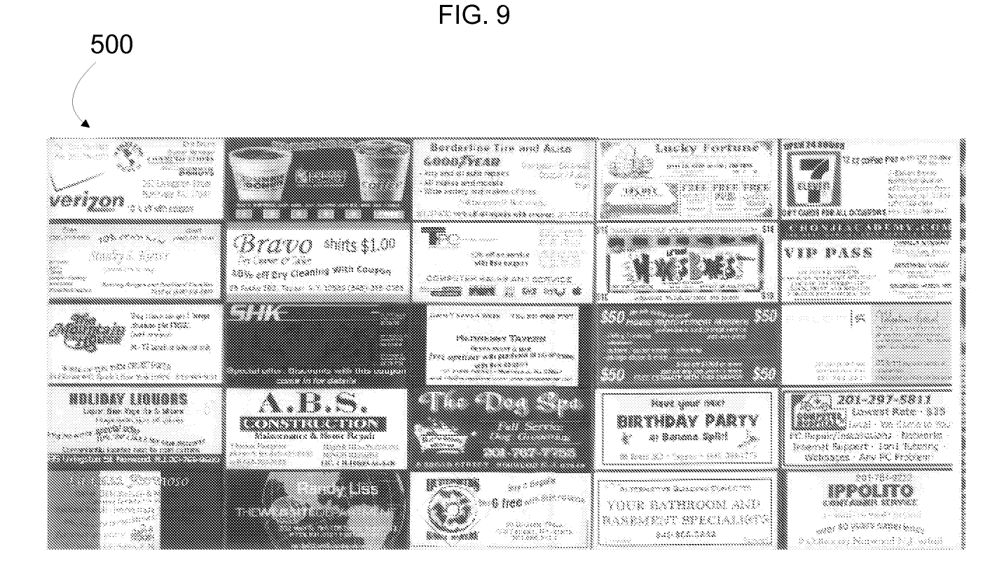

While a tri-fold mailer has been previously described, it will be appreciated that the mailer can be folded in other manners. Thus, for example, as seen in FIG. 8, a bi-fold mailer 400 is provided, while as seen in FIG. 9, a five-fold mailer 500 is provided. Other numbers of folds can be provided, and the folds can be in one or two directions. The number of folds provided depends primarily on the sizes and number of advertisements that are to be included, and the final folded size of the mailer. Because it is desirable to keep costs to a minimum, a final folded size of less than 6.125×11.5 inches (and more than 3.5×5.0 inches) is desired in the United States in order to qualify for bulk mailing rates without surcharges for oversized or undersized mail.

With the provided mailers of the various embodiments, it will be appreciated that when a customer receives the mailer, it will be easy for the customer to open the mailer and look at the advertisements and there will be no need to thumb through a stack of separate advertisements. Thus, it is more likely that the customer will at least look at the advertisements of the mailers of the invention than the standard envelope mailers presently utilized. In addition, because the advertisements are preferably laid out in a grid, if the customer wishes to remove an advertisement because of a coupon, it is easy for the customer to do so. Where the mailer is scored horizontally and/or vertically, removing a coupon is even easier.

With the mailers as described in FIGS. 1-9, a method which utilizes the mailers includes soliciting at least six advertisers to contract for advertising space in a direct mailer consisting essentially of a single piece of folded paper having on one side an addressee indicator and a postage indicator and having on the other side the advertisers' advertisements and an indication of coupons associated with at least three of those advertisements. Advertisers may be given options as to the size and/or shape of the advertisements and will typically pay accordingly. After the advertisers have agreed to run their advertisements, the solicitor will generate the mailer by doing or causing the following to be done: laying out the advertisers' advertisements, printing the advertisements on one side of the paper, folding the paper to a final folded size which permits the mailer to qualify for bulk mail rates, and securing the paper so that it will not open. The printing, folding, and securing may all be done by one or more machines in an automatic fashion as is well known in the art. In addition, indications of addresses and postage will be applied to non-advertisement side of the mailer paper, which likewise may be accomplished by one or more machines in an automatic fashion prior to, concurrent with, or after printing of the advertisement side, as is well known in the art. A return address may also be applied. If desired, other printed matter may be applied to the “non-advertisement” side of the mailer as previously described to make the mailer more attractive, and/or to indicate the contents of the mailer, and/or to advertise the mailer itself, and/or to provide additional advertisements, etc. Once completed, to qualify for bulk mailing, the mailer is sent to at least two hundred addressee recipients and preferably to thousands of addressee recipients.

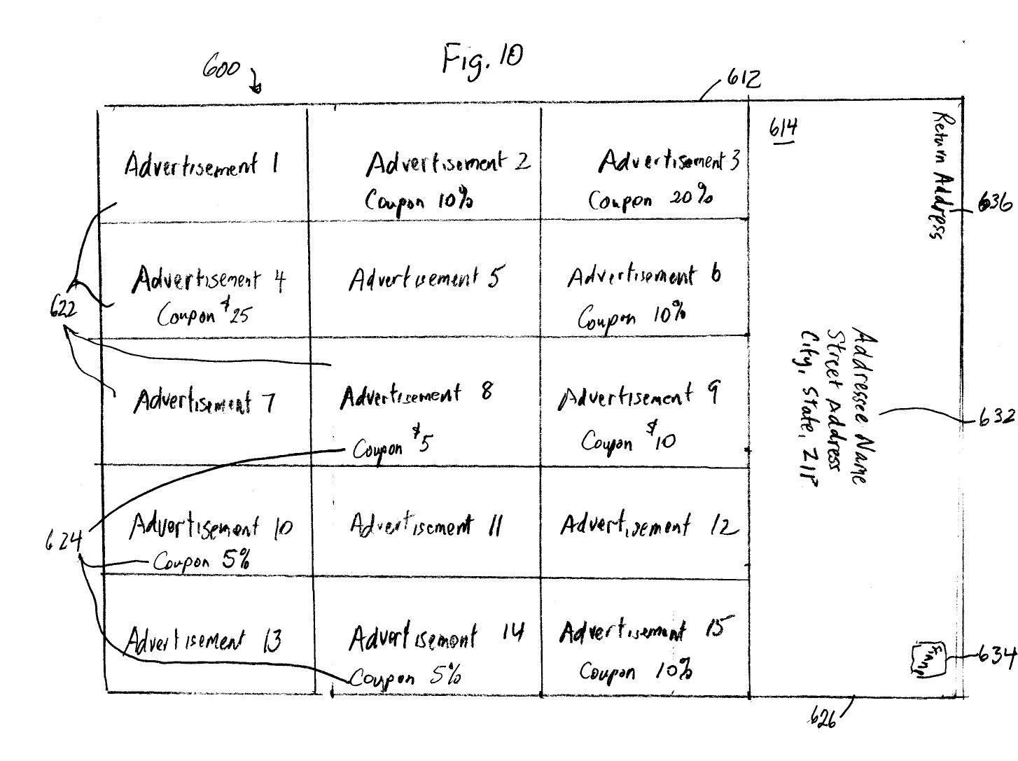

Turning now to FIG. 10, in yet another embodiment of the invention, a mailer 600 is provided. Mailer 600 is a quad-fold mailer which consists essentially of a single piece of paper 612 having a first side 614 and a second side (not shown). The first side 614 includes at least six printed advertisements 622 of advertisers. At least three of those advertisements have discount coupons 624 associated therewith. In addition, the first side 614 includes a quad-fold portion 626 having an indicator 632 of an addressee and a postage indicator 634 which may be printed or applied with labels and stamps. If desired, an indication 636 of a return address may be provided either by printing or label on the first side. The addressee indicator 632 is generally centrally located in the quad-fold portion 626, while the postage indicator 634 is located in a top right-hand side of the quad-fold portion 626 and the indicator 636 of a return address is provided in a top left-hand side of the quad-fold portion 626. As will be appreciated by those skilled in the art, because numerous mailers are generated and sent, the addressee will change for each mailer (i.e., indicator 632 will change on each piece of paper generated). However, for any given mailing, the advertisements 622 will be the same. It will also be appreciated that the second side of the mailer 600 can contain printed matter as previously described with respect to the mailers of FIGS. 1-9 to make the mailer more attractive, and/or to indicate the contents of the mailer, and/or to advertise the mailer itself, and/or to provide additional advertisements, etc. Also, other than having its addressee and postage indicators on the same side as the advertisements, the mailer 600 can be arranged as described with respect to the embodiments of FIGS. 1-9. Thus, the mailer 600 can have different numbers of folds, can have horizontal and/or vertical scoring, can have advertisements laid out in any desired format with different sizes, can include an indication that all advertisements 322 of the mailer are entitled to a particular discount, etc.

For mailing purposes, the mailer 600 of FIG. 10 must be folded differently than the mailers of FIGS. 1-9. More particularly, the section containing the addressee and postage indicators must be folded back instead of down so that the second side of the paper opposite the section containing the addressee and postage indicators will back onto the second side of the paper opposite a section containing advertisements. It will therefore be desirable when the mailer is folded into its mailing position to provide two securing means (not shown) on opposite sides of the folded mailer to prevent the mailer from unfolding.

With the mailer 600 of FIG. 10, the method described above which is associated with the mailers of FIGS. 1-9 should be modified slightly by: (i) accounting in the lay-out for the addressee and postage indicators to be located on the same side as the advertisements in an appropriate location; (ii) applying the addressee and postage indicators to the same side as the advertisements; (iii) folding the mailer differently; and preferably (iv) securing the folded mailer differently.

There have been described and illustrated herein several embodiments of mailers and related methods. While particular embodiments of the invention have been described, it is not intended that the invention be limited thereto, as it is intended that the invention be as broad in scope as the art will allow and that the specification be read likewise. Thus, while particular sized mailers have been disclosed, it will be appreciated that mailers of other sizes can be generated if bulk mailing discount is not utilized. In addition, while the mailer has been described as consisting essentially of a single piece of paper, it will be appreciated that the mailer could be made of any quality paper, cardboard, or plastic, provided that the mailer can be folded appropriately and secured closed. Further, while the mailers have been shown having a top portion of the “non-advertising” side containing the addressee and postage indicators, it will be appreciated that the addressee and postage indicators could be located in a middle portion or a bottom portion of the non-advertising side, provided the mailer is folded properly so that the addressee and postage are properly presented. Further yet, while the mailers have been described as having the advertisements and the addressee and postage indicators being printed, it will be appreciated that the advertisements could be separately formed and attached (e.g., as labels) to the mailer material in a manner similar to having an addressee label and stamp separately formed and attached to the mailer. Also, while the mailers have been described as consisting essentially of a single piece of paper which is folded, the mailer can constitute a postcard which is not folded provided it includes the addressee and postage indicators on one side and at least six advertisers' advertisements and an indication of discounts associated with at least three of those advertisements on the other side. The postcard can have horizontal and/or vertical scoring, can have advertisements laid out in any desired format with different sizes, can include an indication that all advertisements of the mailer are entitled to a particular discount, etc. It will therefore be appreciated by those skilled in the art that yet other modifications could be made to the provided invention without deviating from its spirit and scope as claimed.

I claim:

1. A direct mailer consisting essentially of a single piece of paper, plastic, or cardboard having on a first side an addressee indicator and a postage indicator and having on a second side at least six advertisers' advertisements and an indication of discounts associated with at least three of those advertisements.

2. A direct mailer according to claim 1, wherein said single piece is a folded piece of paper.

3. A direct mailer according to claim 2, wherein said single piece has a final folded size of at most 6.125 inches by 11.5 inches.

4. A direct mailer according to claim 2, wherein said advertisements are laid out in a grid having a grid block size.

5. A direct mailer according to claim 4, wherein all said advertisements are the same size.

6. A direct mailer according to claim 4, wherein at least to of said advertisements are of different size and are sized to constitute an integer number of grid blocks.

7. A direct mailer according to claim 4, wherein said grid has rectangular blocks.

8. A direct mailer according to claim 2, wherein said single piece is scored.

9. A direct mailer according to claim 2, wherein said single piece is scored in two perpendicular directions.

10. A direct mailer according to claim 2, wherein at least fifty percent of said advertisements have a coupon associated therewith.

11. A direct mailer according to claim 2, further including securing means for keeping said mailer in a folded position.

12. A direct mailer according to claim 11, wherein said securing means comprises a sticky tab folded over an end of said single piece.

13. A direct mailer according to claim 2, wherein said at least six advertisers' advertisements and said indication of discounts is printed on said second side.

14. A direct mailer according to claim 13, wherein said addressee indicator is printed or provided on a label, and said postage indicator is printed or provided as a stamp.

15. A method, comprising:
soliciting at least six advertisers to contract for advertising space in a direct mailer consisting essentially of a single piece of paper having on a first side an addressee indicator and a postage indicator and having on a second side the advertisers' advertisements and an indication of coupons associated with at least three of those advertisements;
generating at least two hundred of the direct mailers with at least two hundred different addressee recipients; and
mailing the direct mailers to the at least two hundred addressee recipients.

16. A method according to claim 15, wherein said generating comprises laying out the advertisers' advertisements, printing the advertisements on one side of the paper, folding the paper and securing the paper so that it will not open.

17. A method according to claim 16, wherein said folding comprises folding the paper to a final folded size which permits the mailer to qualify for bulk mail rates, and said mailing comprises mailing at a bulk mail rate.

18. A method according to claim 16, wherein said generating comprises printing said addressee indicator and said postage indicator on said first side.

19. A direct mailer consisting essentially of a single piece of folded paper, plastic, or cardboard having on one side an addressee indicator and a postage indicator in a first folded portion of said direct mailer, and having at least six advertisers' advertisements and an indication of discounts associated with at least three of those advertisements in at least second and third folded portions of said direct mailer.

20. A direct mailer according to claim 19, further comprising securing means for keeping said mailer in a folded position, wherein said single piece has a final folded size of at most 6.125 inches by 11.5 inches.
